(19) United States
(12) Patent Application Publication
(10) Pub. No.: US 2026/0169666 A1
(43) Pub. Date: Jun. 18, 2026

(54) IMAGE FORMING APPARATUS, METHOD FOR CONTROLLING THE IMAGE FORMING APPARATUS, AND RECORDING MEDIUM

(71) Applicant: CANON KABUSHIKI KAISHA, Tokyo (JP)

(72) Inventor: YUICHIRO SATO, Kanagawa (JP)

(21) Appl. No.: 19/413,809

(22) Filed: Dec. 9, 2025

(30) Foreign Application Priority Data
Dec. 16, 2024 (JP) 2024-220217

(51) Int. Cl. G06F 3/12

(52) U.S. Cl. CPC G06F 3/1256; G06F 3/1205; G06F 3/1219

(57) ABSTRACT

After an image of a printing job has been printed using a print setting for test printing instead of a print setting for the printing job based on a fact that the test printing is set to be enabled, the likelihood that a user forgets to disable the setting of the test printing is suppressed.

### BACKGROUND

### Field of the Technology

The present disclosure relates to an image forming apparatus having a test printing function, a method for controlling the image forming apparatus, and a recording medium.

### Description of the Related Art

It is known that image forming apparatuses have a function of adjusting a print result in accordance with device setting values, which include device adjustment items such as offset values of an image position for borderless printing and toner density.

It is also known that the image forming apparatuses have a test printing function and a preview function for verifying the correctness of print settings through actual printing.

Japanese Patent Application Laid-Open No. 2001-246820 proposes a technique for verifying the correctness of print settings while reducing waste of paper by changing an image layout or duplex setting when printing is performed in a trial printing mode that is designated to instruct test printing.

Japanese Patent No. 06424569 proposes a technique to verify, in advance via a preview, a region to be printed, a region that may be printed depending on the paper size, and a region outside the paper, in accordance with margin settings.

Regarding results of setting of the device setting values, actual printing results are to be visually checked depending on the setting item.

For example, in the case of the offset values of the image position for the borderless printing, it is visually checked whether the image is printed to the edges of the sheet. In the case of the toner density, it is visually checked whether the printing is performed with the desired density.

Furthermore, in determining the device setting values to obtain the desired printing result, changes in the device setting values and the visual check of the printing result are to be repeatedly performed.

Since printing results during this trial-and-error are to be discarded after the verification, consumables such as toner and sheets are wasted.

In particular, when an original in which an image is printed over the entirety of the sheet, a color original, or an original having a plurality of pages are used for the verification, the waste of consumables becomes significant.

### SUMMARY

According to some embodiments, an image forming apparatus includes a setting unit configured to set whether to enable test printing based on an instruction by a user, a receiving unit configured to receive a printing job, a printing unit configured to print an image of the printing job using a print setting for the test printing instead of a print setting for the printing job received by the receiving unit based on a fact that the test printing is set to be enabled by the setting unit, and a changing unit configured to change the setting, by the setting unit, to disable the test printing in accordance with completion of the printing of the image by the printing unit.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a hardware configuration of an image forming apparatus.

FIG. 2 illustrates a software configuration of the image forming apparatus.

FIG. 3 illustrates a configuration of a printing job.

FIG. 4 illustrates an example of a device setting screen of an image forming apparatus according to embodiment 1.

FIG. 5A is a flowchart of the image forming apparatus according to embodiment 1.

FIG. 5B is a flowchart of the image forming apparatus according to embodiment 1.

FIG. 6A illustrates an example of image data of the printing job according to embodiment 1.

FIG. 6B illustrates an example of an output result of the printing job according to embodiment 1.

FIG. 7 is a flowchart illustrating a printing process of an image forming apparatus according to embodiment 2.

FIG. 8 illustrates an example of a verify result screen of an image forming apparatus according to embodiment 3.

FIG. 9 is a flowchart illustrating a process for changing device setting values of the image forming apparatus according to embodiment 3.

FIG. 10 is a flowchart illustrating a printing process of the image forming apparatus according to embodiment 3.

FIG. 11 illustrates an example of the device setting screen of an image forming apparatus according to embodiment 4.

FIG. 12 is a flowchart illustrating a printing process of the image forming apparatus according to embodiment 4.

FIG. 13 is a flowchart illustrating the process for changing device setting values of the image forming apparatus according to embodiment 4.

### DESCRIPTION OF THE EMBODIMENTS

Hereinafter, forms for embodying the present technique will be described with reference to the drawings.

### Embodiment 1

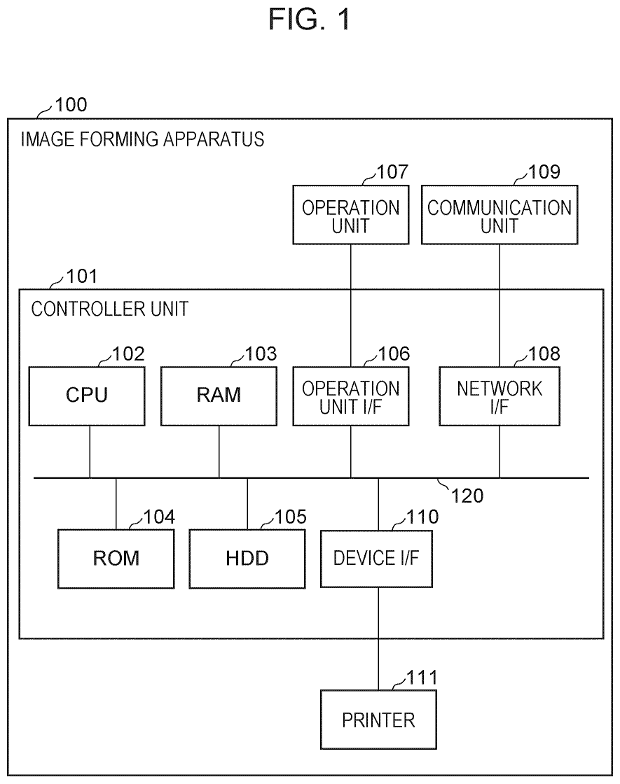

FIG. 1 is a block diagram illustrating a hardware configuration of an image forming apparatus 100 according to the present embodiment.

The image forming apparatus 100 includes a controller unit 101 configured to control a printer 111, an operation unit 107, and a communication unit 109.

When a user uses a printing function, the controller unit 101 controls the printer 111 to print an image on a sheet and output the sheet.

An instruction for execution of a printing process is referred to as a printing job. The image forming apparatus 100 executes the printing process in accordance with the printing job.

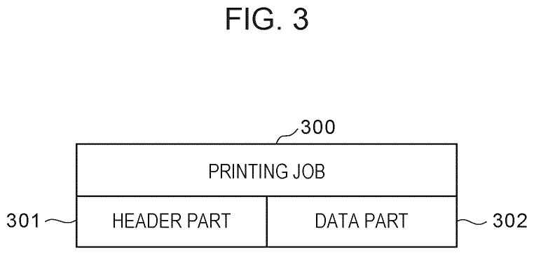

A printing job 300 illustrated in FIG. 3 includes a header part 301 and a data part 302. Printing information is stored in the header part 301. Image data including page description language (PDL) data is stored in the data part 302.

The controller unit 101 includes a central processing unit (CPU) 102, a random access memory (RAM) 103, a read only memory (ROM) 104, a hard disk drive (HDD) 105, an operation unit interface (I/F) 106, a network I/F 108, and a device I/F 110. These components of the controller unit 101 are connected via a system bus 120.

The CPU 102 is configured to control the whole system of the image forming apparatus 100.

The RAM 103 is system work memory for operation of the CPU 102 and image memory for temporarily storing image data.

Furthermore, in the RAM 103, programs such as an operating system, system software, application software and data are disposed and the printing job received from the controller unit 101 via a network is stored.

A boot program of the system is stored in the ROM 104. The operating system, the system software, the application software, the printing job, setting data, and the like are stored in the HDD 105.

The operation unit I/F 106 is an interfacing portion with the operation unit 107 configured to output information to be displayed by the operation unit 107 to the operation unit 107.

Furthermore, the operation unit I/F 106 accepts information input by the user from the operation unit 107.

The network I/F 108 is connected to the communication unit 109 so as to, for example, control various types of communication with an external apparatus and receive the printing job.

The device I/F 110 connects the printer 111 that prints the image data and the controller unit 101 and outputs the image data.

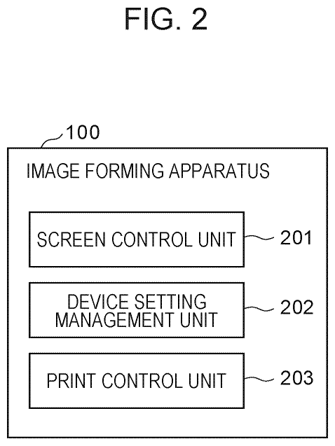

FIG. 2 is a block diagram illustrating a software configuration of the image forming apparatus 100 according to the present embodiment.

The image forming apparatus 100 includes a screen control unit 201, a device setting management unit 202, and a print control unit 203.

The screen control unit 201 is configured to control the operation unit 107 via the operation unit I/F 106 so as to accept the information input by the user using the operation unit 107 and generate a screen to be displayed in the operation unit 107.

The device setting management unit 202 is configured to store, in the HDD 105, device setting values for adjusting inter-device variation of the image forming apparatus 100, display the device setting values in the operation unit 107 via the screen control unit 201, and change the device setting values into values input by the user via the operation unit I/F 106.

The device setting management unit 202 further manages a test output flag, which determines whether to perform a test output to verify the correctness of the device setting values.

Examples of the device setting values include, for example, offset values of an image position when an image is drawn in a sheet, toner density for changing printing density, and the like.

The print control unit 203 is configured to control the printer 111 via the device I/F 110 so as to print the image data on the sheet and output the sheet.

Each block illustrated in FIG. 2 represents software stored in the ROM 104 or the HDD 105. The CPU 102 reads the software into the RAM 103 and executes it to implement the processes shown in the flowcharts, which will be described later.

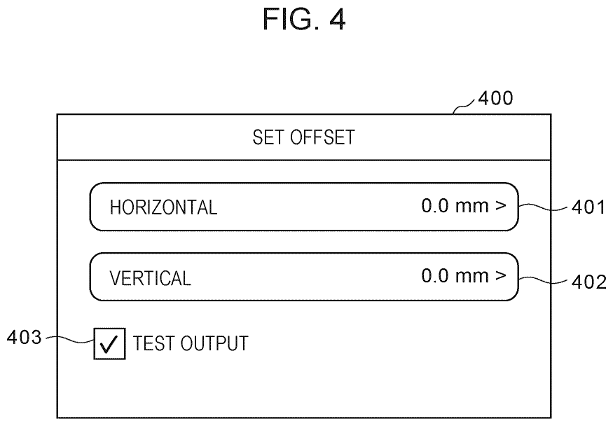

FIG. 4 illustrates an example of a device setting screen 400 displayed by the device setting management unit 202 in the operation unit 107 via the screen control unit 201.

In the description of the present embodiment, as the examples of the device setting values, offset values of an image position when an image is drawn in a sheet are used.

The device setting screen 400 includes a horizontal offset 401, a vertical offset 402, and a test output check box 403 (test printing function).

The horizontal offset 401 is a component for displaying and setting an offset amount of the image position in the horizontal direction when the image is drawn on the sheet. The user changes the setting by selecting the horizontal offset 401 and inputting a value by using a screen keyboard (not illustrated).

The vertical offset 402 is a component for displaying and setting an offset amount of the image position in the vertical direction when the image is drawn on the sheet. The user changes the setting by selecting the vertical offset 402 and inputting a value by using a screen keyboard (not illustrated).

The test output check box 403 is a check box for displaying and setting an ON or OFF value of the test output flag. The test output flag determines whether to perform test printing for verifying the offset amounts set by using the horizontal offset 401 and the vertical offset 402.

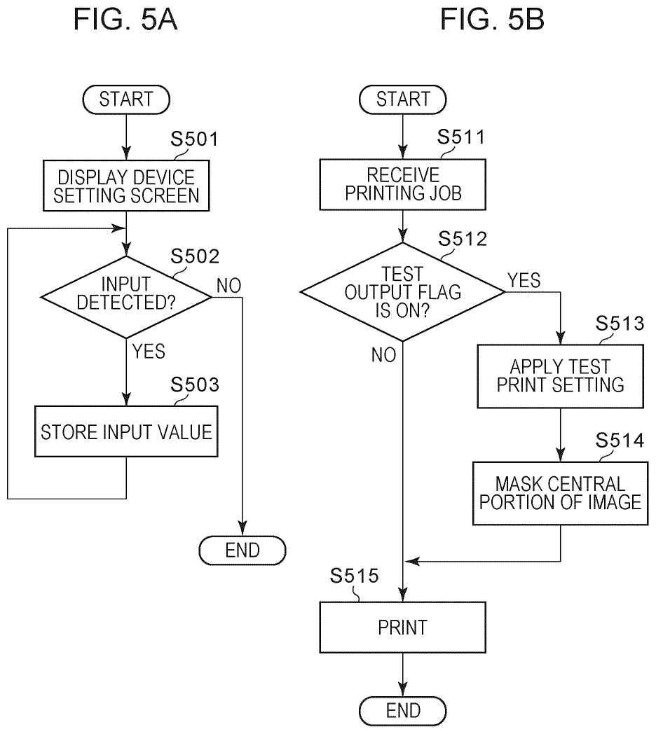

FIG. 5A is a flowchart for explaining a process for changing device setting values executed by the image forming apparatus 100 according to embodiment 1.

The CPU 102 of the image forming apparatus 100 reads the programs for implementing software modules stored in the ROM 104 or the HDD 105 into the RAM 103 and executes the programs so as to implement the software modules.

The process starts when the screen control unit 201 detects that the user instructs to call the device setting screen 400 in a menu screen (not illustrated) displayed in the operation unit 107.

In step S501, the device setting management unit 202 displays the device setting screen 400 via the screen control unit 201.

In step S502, the process proceeds to step S503 when the screen control unit 201 detects that a value is input, by the user, to the horizontal offset 401, the vertical offset 402, or the test output check box 403.

In step S502, when the screen control unit 201 detects that an exit button (not illustrated) is pressed down in the operation unit 107, the screen control unit 201 ends the flowchart.

In step S503, the device setting management unit 202 stores the input device setting values in the HDD 105, and the process proceeds to step S502.

According to the present embodiment, the device setting values are the horizontal offset value input by using the horizontal offset 401, the vertical offset value input by using the vertical offset 402, and the state of the test output flag set in the test output check box 403.

FIG. 5B is a flowchart illustrating the printing process executed by the image forming apparatus 100 according to embodiment 1.

The CPU 102 reads the programs for implementing software modules stored in the ROM 104 or the HDD 105 into the RAM 103 and executes the programs so as to implement the software modules.

The flowchart illustrated in FIG. 5B starts when the image forming apparatus 100 receives the printing job based on a print instruction from a client personal computer (PC, not illustrated).

In step S511, the print control unit 203 receives the printing job and proceeds to step S512.

In step S512, the print control unit 203 acquires the value of the test output flag via the device setting management unit 202. When the test output flag is ON, the print control unit 203 proceeds to step S513. When the test output flag is OFF, the print control unit 203 proceeds to step S515.

In step S513, the print control unit 203 changes the header part 301 of the printing job 300 into a test print setting and proceeds to step S514.

The change into the test print setting reduces consumption of consumables and has no relationship with the verification of the offset values. That is, the change into the test print setting may be any setting change that allows verification of a border portion of the sheet in a print result.

Any or all of the following changes may be allowed: a change of a color printing job case into a monochrome print setting; minimization of the toner density; and limitation of the printing range to the first page only.

In step S514, the print control unit 203 masks a central portion of the image data included in the data part 302 of the printing job and proceeds to step S515.

Specifically, the print control unit 203 acquires a sheet size setting from the header part of the printing job, and generates and disposes a white rectangular image, having a reduced size based on the acquired sheet size, at the center of the image data.

Thus, the central part of the sheet is masked, and nothing is drawn in this part. It is sufficient that the rectangular image disposed here have a size that allows verification of the drawing in the border portion of a printing region. The rectangular image may be formed, on a case-by-case basis, to have a size reduced by a fixed rate based on the sheet size. Alternatively, rectangular images of various sizes may be held in the print control unit 203 in advance, and a rectangular image may be selected in accordance with the sheet size.

In step S515, the print control unit 203 acquires a horizontal offset value and a vertical offset value from the device setting management unit 202, changes the image position in accordance with the acquired horizontal and vertical offset values, performs printing by the printer 111, and ends the flowchart.

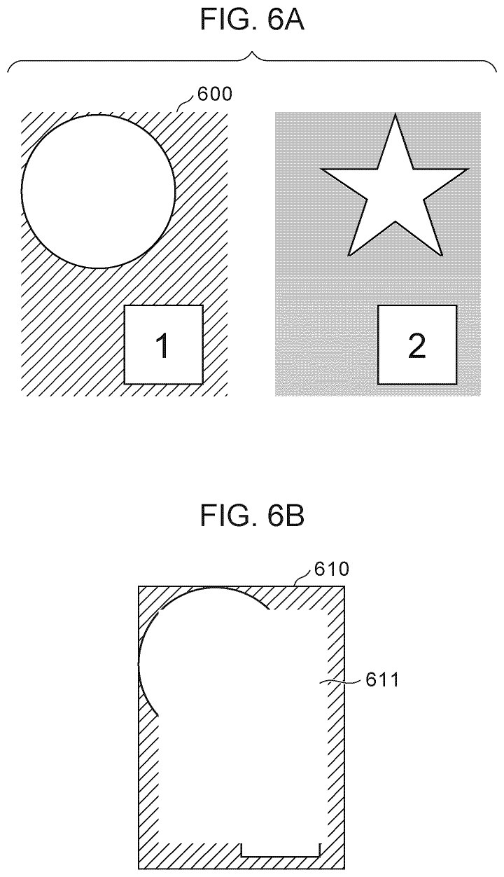

FIGS. 6A and 6B illustrate examples of the image data and output results of the printing job according to the present embodiment.

Input image data 600 illustrated in FIG. 6A is an example of image data of the printing job transmitted to the image forming apparatus 100 based on the print instruction from a client PC (not illustrated). The input image data 600 includes image data extending over two pages.

FIG. 6B illustrates an example of a test output result 610 formed by performing test printing of the printing job including the input image data 600 according to the present embodiment.

In step S513 described above, due to the change in the printing range performed by the print control unit 203, only the first page of the input image data 600 is printed as the output result 610.

Furthermore, a masked region 611 of the test output result 610 is the central portion of the printing region in step S514, that is, a region formed by masking the central part of the sheet.

When the masked region 611 is drawn in the central portion of the printing region without the border portion of the sheet, a minimum image, that is, an image of only a boundary portion is printed. Thus, it can be verified that printing of the border portion of the sheet is in a desirable state.

In the present embodiment, a test printing process for verifying whether the offset amounts out of the device setting values are in the desirable state has been described. However, the test printing may also be performed for other device setting values.

At this time, the print control unit 203 changes the print setting for allowing verification of the content of testing in step S513. For example, in the case of test printing of the toner density value for the verification of the printing density, only the printing range is changed, without changing the toner density or the color mode.

A printing range to be verified may be set (the toner density is tested in the set printing range).

As described above, according to the present embodiment, a subset of the print setting of the printing job and part of the image data are masked in the test printing for verifying the correctness of the device setting values as in steps S512 to S514 in FIG. 5B. Thus, wasteful consumption of consumables for verifying the setting values can be reduced.

### Embodiment 2

According to embodiment 1, the user is to turn OFF the test output check box 403 of the device setting screen 400 after the test printing.

In the case where the user forgets to turn OFF the test output check box 403, even when performing of the normal printing is intended in the printing thereafter, the test print setting and the printing with the center masked may be performed again.

In embodiment 2, an embodiment in which normal printing can be performed in printing after the test printing is described. The description of embodiment 2 is dedicated to the difference from an embodiment 1.

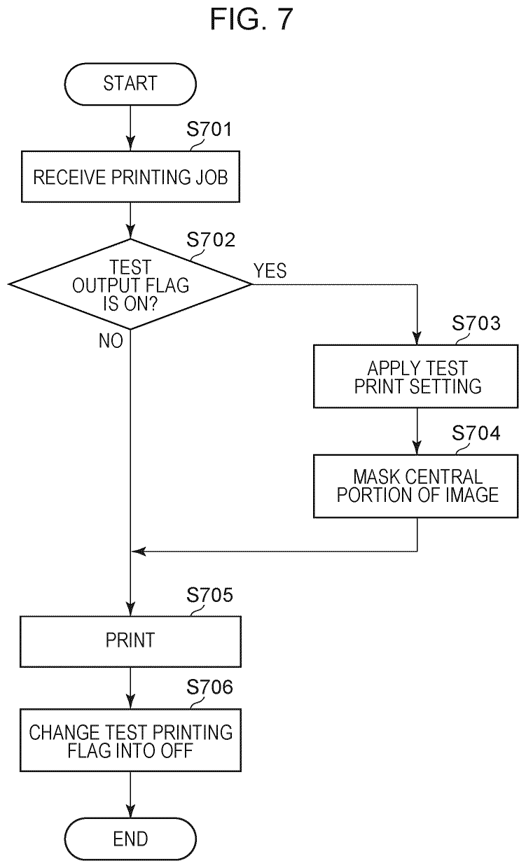

FIG. 7 is a flowchart illustrating a printing process executed by the image forming apparatus 100 according to embodiment 2.

The CPU 102 reads the programs for implementing the software modules stored in the ROM 104 or the HDD 105 into the RAM 103 and executes the programs so as to implement the software modules.

The flowchart illustrated in FIG. 7 starts when the image forming apparatus 100 receives a printing job based on a print instruction from a client PC (not illustrated).

Steps S701 to S705 are respectively similar to steps S511 to S515. Thus, description of steps S701 to S705 is omitted.

In step S706, the print control unit 203 changes, via the device setting management unit 202, the value of the test output flag into OFF (disables the test printing function) and ends the flowchart.

As described above, according to the present embodiment, the test output flag can be set to OFF after the test printing, and wasteful consumption of consumables due to unnecessary test printing can be reduced.

### Embodiment 3

According to embodiment 1, when the device setting values are to be further changed after the test printing, the user is to operate the operation unit 107 of the image forming apparatus 100 to display the device setting screen 400 again for changing the device setting values.

In embodiment 3, an embodiment in which the user is inquired of whether an intended print result is acquired after the test printing, and transition to the device setting screen can be easily performed is described.

The description of embodiment 3 is dedicated to the difference from embodiment 1.

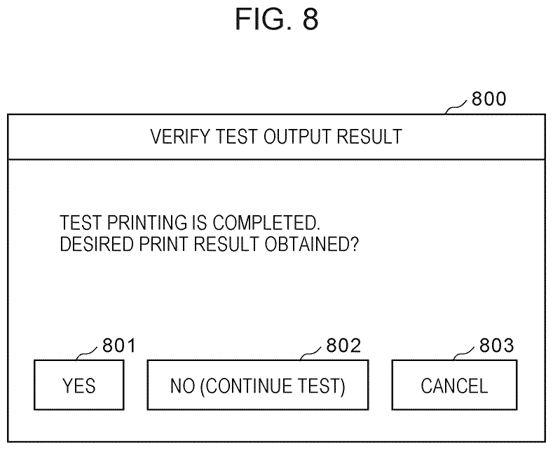

FIG. 8 illustrates an example of a verify test output result screen 800 displayed after the test printing by the print control unit 203 in the operation unit 107 via the screen control unit 201 in embodiment 3.

The verify test output result screen 800 includes a yes button 801, a no button 802, and a cancel button 803.

The yes button 801 is for issuing an instruction to set the above-described test output flag to OFF when the test print result is a desired print result.

The no button 802 is for issuing an instruction to display the device setting screen 400 when the test print result is not a desired print result.

The cancel button 803 is for issuing an instruction to cancel the change in the device setting values.

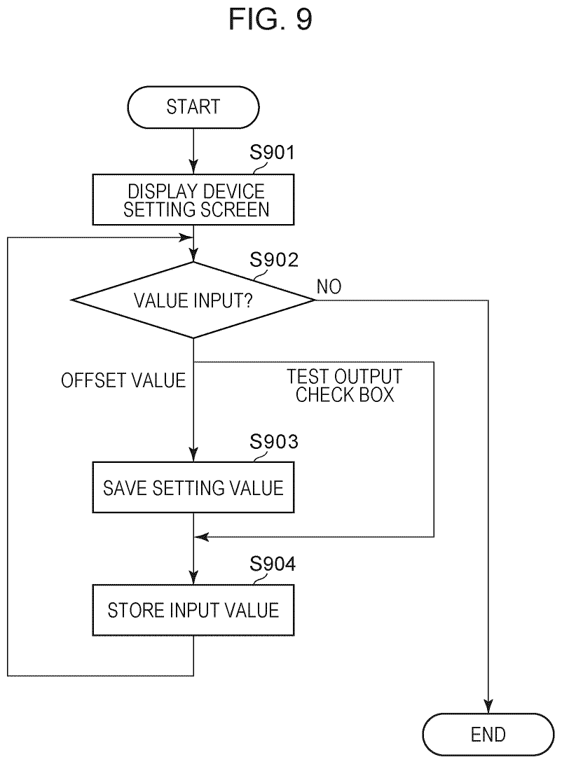

FIG. 9 is a flowchart for explaining a process for changing device setting values executed by the image forming apparatus 100 according to embodiment 3.

The CPU 102 of the image forming apparatus 100 reads the programs for implementing the software modules stored in the ROM 104 or the HDD 105 into the RAM 103 and executes the programs so as to implement the software modules.

The process starts when the screen control unit 201 detects that the user instructs to call the device setting screen 400 in the menu screen (not illustrated) displayed in the operation unit 107.

Steps S901 and S904 are respectively similar to steps S501 and S503. Thus, description of steps S901 and S904 is omitted.

In step S902, the process proceeds to step S903 when the screen control unit 201 detects that a value is input, by the user, to the horizontal offset 401 or the vertical offset 402.

When input of a value to the test output check box 403 is detected, the process proceeds to step S904.

In step S902, when the screen control unit 201 detects that the exit button (not illustrated) displayed by the operation unit 107 is pressed down by the user, the screen control unit 201 ends the flowchart.

In step S903, the device setting management unit 202 acquires the stored device setting values from the HDD 105 and stores the acquired device setting values in the RAM 103 as the original values so as to save the original device setting values. The process proceeds to step S904.

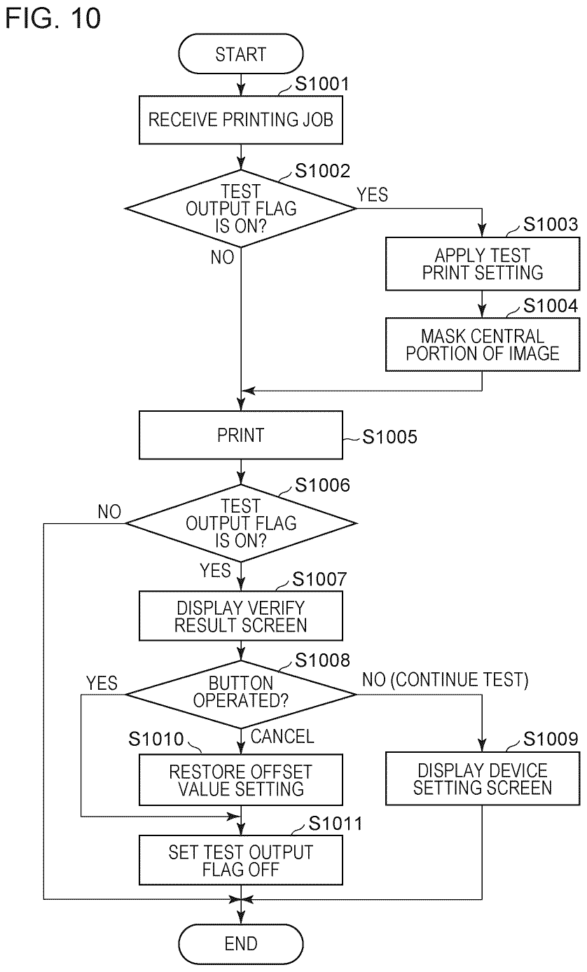

FIG. 10 is a flowchart illustrating a printing process executed by the image forming apparatus 100 according to embodiment 3.

The CPU 102 reads the programs for implementing the software modules stored in the ROM 104 or the HDD 105 into the RAM 103 and executes the programs so as to implement the software modules.

Steps S1001 to S1005 are respectively similar to steps S511 to S515. Thus, description of steps S1001 to S1005 is omitted.

In step S1006, the device setting management unit 202 acquires the value of the test output flag. When the test output flag is ON, the device setting management unit 202 proceeds to step S1007. When the test output flag is OFF, the device setting management unit 202 ends the flowchart.

In step S1007, the device setting management unit 202 displays the verify test output result screen 800 in the operation unit 107 via the screen control unit 201 and proceeds to step S1008.

In step S1008, when the device setting management unit 202 detects, via the screen control unit 201, that the yes button 801 is pressed down by the user, the device setting management unit 202 proceeds to step S1011.

This means that the user has acquired the desired print result in the test printing, and the device setting values have been finalized.

In step S1008, when the device setting management unit 202 detects, via the screen control unit 201, that the no button 802 is pressed down by the user, the device setting management unit 202 proceeds to step S1009. This means that the user has not acquired the desired print result in the test printing, and the device setting values are to be changed further.

In step S1008, when the device setting management unit 202 detects, via the screen control unit 201, that the cancel button 803 is pressed down by the user, the device setting management unit 202 proceeds to step S1010. This means that the user cancels the change in the device setting values.

In step S1009, the device setting management unit 202 displays the device setting screen 400 via the screen control unit 201 and ends the flowchart.

In step S1010, the device setting management unit 202 changes the device setting values into the values having been saved as the original values in step S903 so as to cancel the changes in the device setting values to restore the device setting values to the original values and proceeds to step S1011.

In step S1011, the device setting management unit 202 sets the value of the test output flag to OFF and ends the flowchart.

As described above, according to the present embodiment, the user is inquired of whether an intended print result is acquired after the test printing. When the intended print result has not been acquired, the device setting screen 400 is displayed. This facilitates changing of the device setting values again, and improves usability.

### Embodiment 4

In embodiment 1, when the desired print result has not been acquired in the test printing, the device setting values are changed and the test printing is performed again. At this time, the user is to instruct again, from the client PC (not illustrated), the image forming apparatus 100 to print.

In embodiment 4, an embodiment in which, after the test printing, test printing can be easily re-executed without issuing a print instruction from the client PC is described.

The description of embodiment 4 is dedicated to the difference from an embodiment 1.

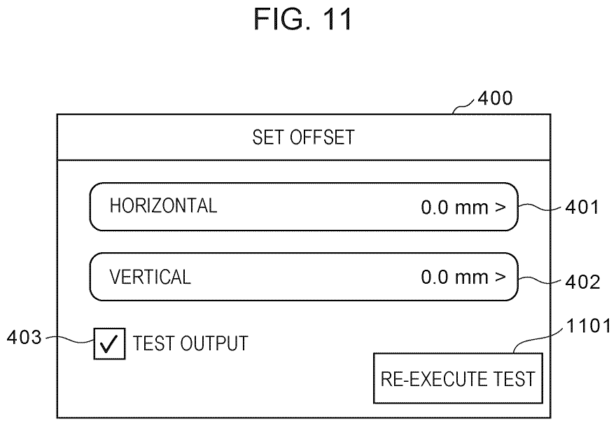

FIG. 11 illustrates an example of the device setting screen 400 displayed by the device setting management unit 202 in the operation unit 107 via the screen control unit 201 according to embodiment 4.

The device setting screen 400 includes the horizontal offset 401, the vertical offset 402, the test output check box 403, and a re-execute test button 1101.

The re-execute test button 1101 is used to instruct the execution of the test printing based on the same printing job as that of the previous test printing. The re-execute test button 1101 is displayed only when the test printing job is present.

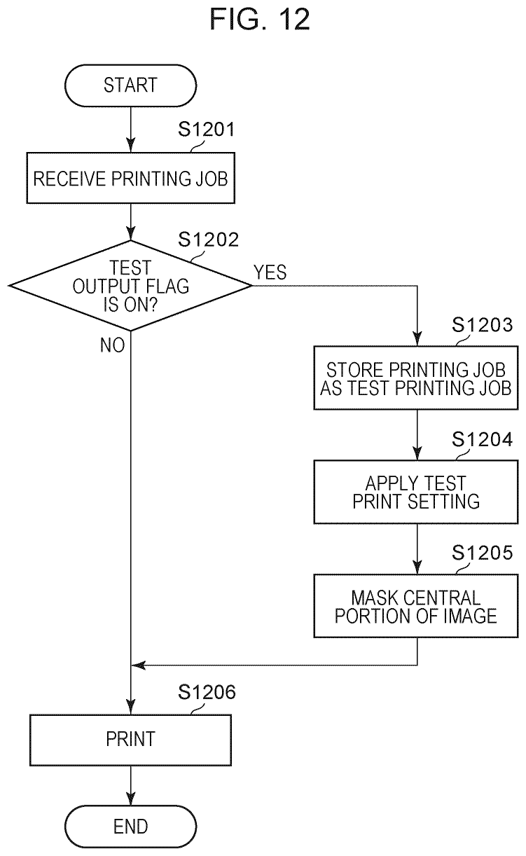

FIG. 12 is a flowchart illustrating a printing process executed by the image forming apparatus 100 according to embodiment 4.

The CPU 102 reads the programs for implementing the software modules stored in the ROM 104 or the HDD 105 into the RAM 103 and executes the programs so as to implement the software modules.

Steps S1201, S1202, S1204 to S1206 are respectively similar to steps S511 to S515. Thus, description of steps S1201, S1202, S1204 to S1206 is omitted.

In step S1203, the print control unit 203 stores the printing job received in step S1201 in the HDD 105 as the test printing job and proceeds to step S1204.

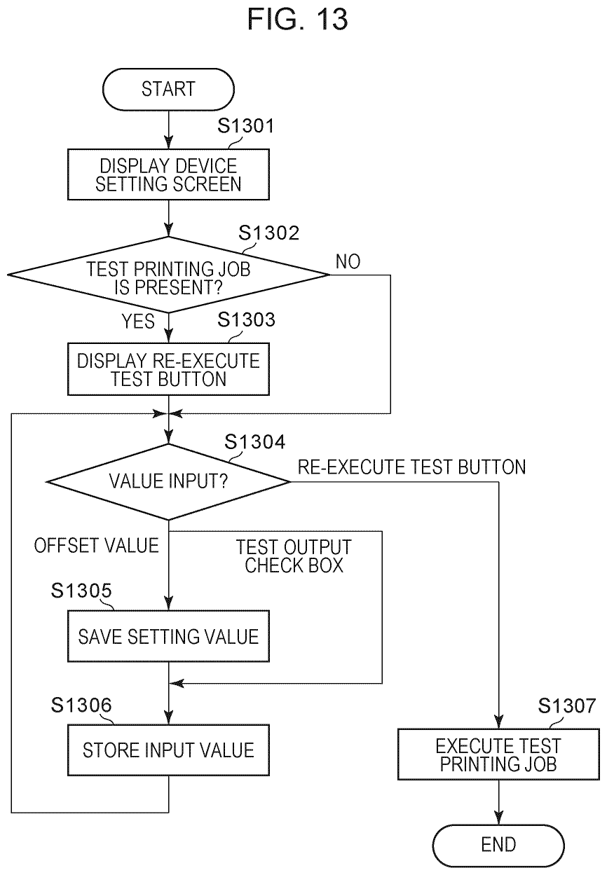

FIG. 13 is a flowchart for explaining a process for changing device setting values executed by the image forming apparatus 100 according to embodiment 4.

The CPU 102 of the image forming apparatus 100 reads the programs for implementing the software modules stored in the ROM 104 or the HDD 105 into the RAM 103 and executes the programs so as to implement the software modules.

The process starts when the screen control unit 201 detects that the user instructs to call the device setting screen 400 in the menu screen (not illustrated) displayed in the operation unit 107.

Steps S1301, S1305, and S1306 are respectively similar to steps S901, S903, and S904. Thus, description of steps S1301, S1305, and S1306 is omitted.

In step S1302, the device setting management unit 202 verifies, via the print control unit 203, whether the test printing job is stored in the HDD 105. When the test printing job is stored, the device setting management unit 202 proceeds to step S1303. When the test printing job is not stored, the device setting management unit 202 proceeds to step S1304.

In step S1303, the device setting management unit 202 displays the re-execute test button 1101 in the device setting screen 400 via the screen control unit 201 and proceeds to step S1304.

In step S1304, when the device setting management unit 202 detects, via the screen control unit 201, that a value is input to the horizontal offset 401 or the vertical offset 402, the device setting management unit 202 proceeds to step S1305.

When input of a value to the test output check box 403 is detected, the process proceeds to step S1306.

In step S1304, when the device setting management unit 202 detects, via the screen control unit 201, that the re-execute test button 1101 is pressed down, the device setting management unit 202 proceeds to step S1307.

In step S1307, the device setting management unit 202 executes printing based on the test printing job via the print control unit 203 and ends the flowchart.

According to the present embodiment, the printing job is stored as the test printing job during the test printing job, and after that, the user presses down the re-execute test button 1101. This facilitates re-execution of the test printing based on the test printing job and improves the usability.

### Different Embodiments

The present disclosure may be a control program configured to implement one or more of the above-described embodiments and to be executed by a computer. The present disclosure may be a recording medium in which this control program is stored.

The present technique is not limited to the above-described embodiments. Various modifications (including organic combinations of the embodiments) are possible based on the gist of the present disclosure. These modifications are not excluded from the scope of the present disclosure. That is, configurations made by combining the above-described embodiments and their modifications are included in the present disclosure.

The present technique can reduce wasteful consumption of consumables for verifying the setting values of the device setting.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220217, filed Dec. 16, 2024, which is hereby incorporated by reference herein in its entirety.

What is claimed is:

1. An image forming apparatus comprising:
a setting unit configured to set whether to enable test printing based on an instruction by a user;
a receiving unit configured to receive a printing job;
a printing unit configured to print an image of the printing job using a print setting for the test printing instead of a print setting for the printing job received by the receiving unit based on a fact that the test printing is set to be enabled by the setting unit; and
a changing unit configured to change the setting, by the setting unit, to disable the test printing in accordance with completion of the printing of the image by the printing unit.

2. The image forming apparatus according to claim 1,
wherein the changing unit changes, based on the fact that the test printing is set to be enabled by the setting unit, the print setting for the printing job received by the receiving unit into the print setting for the test printing.

3. The image forming apparatus according to claim 1,
wherein the print setting for the test printing is for reducing consumption of a consumable not relating to content of the test printing.

4. The image forming apparatus according to claim 3,
wherein, in a case where the content of the test printing is testing of printing density, the printing unit prints the image without changing a setting of a color mode of the printing job into the print setting for the test printing.

5. The image forming apparatus according to claim 3,
wherein, in a case where the content of the test printing is testing of printing density, the printing unit prints the image without changing a setting of density of a recording agent of the printing job into the print setting for the test printing.

6. The image forming apparatus according to claim 1,
wherein, in a case where content of the test printing is testing of a border portion of a printing region, the printing unit prints at least the border portion of the image without printing a central portion of the printing region except for the border portion of the image.

7. The image forming apparatus according to claim 1, further comprising:
an acquiring unit configured to acquire a sheet size of the printing job; and
a generating unit configured to generate, at a center of the image, a white rectangular image having a smaller size than the sheet size acquired by the acquiring unit.

8. The image forming apparatus according to claim 1, further comprising:
a storing unit configured to store the printing job as a test printing job after the image has been printed using the print setting for the test printing; and
a print setting unit configured to set for printing the image,
wherein the printing unit prints the image based on the test printing job stored in the storing unit and the setting by the print setting unit.

9. A method for controlling an image forming apparatus, the method comprising:
setting whether to enable test printing based on an instruction by a user;
receiving a printing job;
printing an image of the printing job using a print setting for the test printing instead of a print setting for the printing job received by the receiving based on a fact that the test printing is set to be enabled by the setting; and
changing to disable the setting of the test printing by the setting of whether to enable the test printing in accordance with completion of the printing of the image in the printing.

10. A non-transitory computer-readable storage medium storing a program including instructions, which when executed by one or more processors of an image forming apparatus, cause the image forming apparatus to perform operations comprising:
setting whether to enable test printing based on an instruction by a user;
receiving a printing job;
printing an image of the printing job using a print setting for the test printing instead of a print setting for the printing job received by the receiving based on a fact that the test printing is set to be enabled by the setting; and
changing to disable the setting of the test printing by the setting of whether to enable the test printing in accordance with completion of the printing of the image in the printing.
